(19) United States
(12) Patent Application Publication
(10) Pub. No.: US 2006/0271538 A1
(43) Pub. Date: Nov. 30, 2006

(54) Method and system for managing files in a file system

(75) Inventors: Boaz Mizrachi, Haifa (IL); Shmuel Ur, Shorashi (IL)

Correspondence Address: Stephen C. Kaufman;IBM CORPORATION, Intellectual Property Law Dept., P.O.Box 218, Yorktown Heights, NY, 10598, US

(73) Assignee: International Business Machines Corporation, Armonk, NY (US)

(21) Appl. No.: 11/135,818

(22) Filed: May 24, 2005

(51) Int. Cl. G06F 7/00

(52) U.S. Cl. 707/7

(57) ABSTRACT

A method and system for managing files in a file system is provided. The method and system generate a signature of a file, the signature storing a plurality of characteristics of the file. The method and system then delete the file from the file system, and enable searching for a substantially identical copy of the file based on the characeristics stored on said signature. The method and system may be used to determine the probability of finding a substantially identical copy of a file prior to deleting said file from a file system, by searching for at least one copy of the file, and calculating a rating of the probability of finding the substantially identical copy of the file based on the results of the search.

### FIELD OF THE INVENTION

The present invention relates generally to the field of information management, search, and retrieval. In particular, the present invention relates to a method and system for managing files in a file system.

### BACKGROUND OF THE INVENTION

The rapid development of the Internet and of means of communication has caused a tremendous rise in the amount and types of information available to users, whether they are end-users or enterprise applications. Industry analysts predicted in 2002 that more data would be generated in the following three years than in all of recorded history.

Although storage means have developed as well, this flood of information has worsened existing problems and created new ones. First, the storage medium, whether it is a hard drive on a Personal Computer (PC) or a storage unit on an enterprise data server, has a finite number of bits available for storage, and therefore, the amount of data that can be stored is limited. Second, navigating and sorting out the required information is becoming more and more complex. Additional problems are related to performance capabilities of the computers, e.g., PC's, servers, etc. As the storage space grows larger, loading the required information consumes more computer resources and more storage resources.

There are additional problems related to the ways that users handle and manage information. There are two typical user and system behaviors. In one, information is typically deleted immediately or very soon after it is accessed, either because of user practice, e.g., to delete most emails after reading them, or because of default system behavior the user is obliged to or simply has not bothered to change, e.g., keeping a browser or media player cache for just a few days. In another, the information is typically stored on the system for much longer periods or indefinitely by default, even if the user does not need the information for future use.

An additional drawback of current file systems is related to popular items. For example, popular email messages which may include storage intensive media, e.g., movies, that are widely distributed may potentially be repeated numerous times through an organization's file system, thus reducing storage efficiency.

Prior-art approaches to managing files in file systems include archiving old or unused files in remote storage or in cheaper or slower computers. Using this approach does not reduce the overall storage space required for storing the files, nor does it improve the ways that the information can be found or retrieved. An additional drawback to this prior-art approach is the likelihood of duplicating information. When a user receives information that he has already archived, duplicates of the information may be created, consuming more storage space.

An additional prior-art approach to increase the storage efficiency of an organization is to express email attachments as pointers to files stored in a central file system. This approach cannot be applied to organizations without a central file system or to individual users who don't have a central file system.

### SUMMARY OF THE INVENTION

In accordance with some embodiments of the present invention, a method and system for managing files in a file system are provided. The method and system generate a signature of a file, the signature storing a plurality of characteristics of the file. The method and system then provide user interface to enable searching for a substantially identical copy of the file based on the characteristics stored on said signature. The method and system may be used to delete the file from the file system. The method and system may be used to determine the probability of finding or retrieving a substantially identical copy of a file prior to deleting the file from a file system, by searching for at least one copy of the file, and calculating a rating of the probability of finding a substantially identical copy of the file based on the results of the search.

There is provided, in accordance with an embodiment of the present invention, a method and system for management of files in a file system. The method and system allow deletion of a file while keeping a signature with characteristics of the deleted file to enable a future search of the deleted file.

One embodiment of the present invention provides a method of managing files in a file system, including generating a signature of a file, the signature storing a plurality of characteristics of the file. The method further includes providing user interface to enable searching for a substantially identical copy of the file based on the characteristics stored on the signature.

One aspect of this embodiment includes deleting the file from the file system.

Another aspect of this embodiment includes searching for at least one copy of said file, and determining a rating of the probability of finding a substantially identical copy of the file based on the results of the search.

One aspect of this embodiment includes deleting the file if the rating is below a given probability threshold.

Yet another aspect of this embodiment includes deleting the file.

In another aspect of this embodiment, the enabling of the search includes presenting a hypertext link to perform a search of the file, the link holding the characteristics of the file.

In yet another aspect of this embodiment, the enabling of the search includes presenting a user interface (UI) button, the UI button holding the characteristics of the file.

In another aspect of this embodiment, the plurality of characteristics may include any one of the following: name of the file, size of the file, type of the file, keywords related to the file, hash function of the file that allows identifying the file.

In still another aspect of this embodiment, the plurality of characteristics includes a pointer to an identical file that was found.

Another aspect of this embodiment includes displaying the rating in proximity to the signature.

In another aspect of this embodiment, the searching is performed in configurable predefined places.

In yet another aspect of this embodiment, the searching is performed in any one of the following: a plurality of storage databases in the Local Area Network (LAN), a plurality of storage databases in the Wide Area Network (WAN), the Internet, and in mail applications.

In another aspect of this embodiment, the searching further includes sending the signature or a subset of the characteristics of the signature to a search engine for searching the file.

Another embodiment of the present invention provides a system for managing files in a file system, including: a file system to store at least one file; a signature generation module to generate a signature of a file, the signature storing a plurality of characteristics of the file; and a search module to search for a substantially identical copy of the file based on the characteristics stored on the signature.

In one aspect of this embodiment, the signature generation module generates a hypertext link to perform a search of the file; the link holds the plurality of characteristics of the file.

In another aspect of this embodiment, the signature generation module generates a user interface (UI) button; the UI button holds the plurality of characteristics of the file.

In yet another aspect of this embodiment, the plurality of characteristics includes any one of the following: name of the file, size of the file, type of the file, keywords related to the file, hash function of the file, that allows identifying the file.

In yet another aspect of this embodiment, the plurality of characteristics includes a pointer to an identical file that was found.

In another aspect of this embodiment, the search module is adapted to search in configurable predefined places.

In still another aspect of this embodiment, the search module is adapted to send the signature or a subset of the characteristics of the signature to a search engine for searching the file.

One embodiment of the present invention provides a method of determining a probability of finding a substantially identical copy of a file prior to deleting the file from a file system, including searching for at least one copy of the file and calculating a rating of the probability of finding a substantially identical copy of the file based on the results of the searching.

In one aspect of this embodiment, the method further includes displaying the rating in proximity to the file.

In another aspect of this embodiment, the method further includes displaying the rating in proximity to a signature of the file.

In yet another aspect of this embodiment, the method further includes comparing the rating and a plurality of characteristics related to the file system to at least one rule of a policy for management of the file system and, if the rule is fulfilled by the rating and the plurality of characteristics related to the file system, automatically deleting the file from the file system.

A further embodiment of the present invention provides a computer software product, including a computer-readable medium in which computer program instructions are stored, which instructions, when read by a computer, cause the computer to perform a method of managing files in a file system, including generating a signature of a file, the signature storing a plurality of characteristics of the file, and enabling searching for a substantially identical copy of the file based on the characteristics stored on the signature.

In one aspect of this embodiment, the computer software product further includes deleting the file from the file system.

In another aspect of this embodiment, the computer software product further includes searching for at least one copy of the file and determining a rating of the probability of finding a substantially identical copy of the file based on the results of the searching.

In yet another aspect of this embodiment, the computer software product further includes deleting the file if the rating is below a given probability threshold.

In still another aspect of this embodiment, the computer software product further includes deleting the file.

A further embodiment of the present invention provides a computer software product, including a computer-readable medium in which computer program instructions are stored, which instructions, when read by a computer, cause the computer to perform a method of determining a probability of finding a substantially identical copy of a file prior to deleting the file from a file system, including searching for at least one copy of the file and calculating a rate of the probability of finding a substantially identical copy of the file based on the results of the searching.

### BRIEF DESCRIPTION OF THE DRAWINGS

Embodiments of the present invention will now be described, by way of examples only, with reference to the accompanying drawings in which:

FIG. 1 is a simplified block diagram of a system for managing a file system according to an embodiment of the present invention;

FIG. 2A is a simplified block diagram of a signature of a deleted file in accordance with an embodiment of the present invention;

FIG. 2B is a simplified diagram of the way a signature may be displayed to the user in accordance with an embodiment of the present invention;

FIG. 3A is a flow chart diagram of a method of managing files in a file system in accordance with an embodiment of the present invention;

FIG. 3B is a flow chart diagram of a method of managing files in a file system in accordance with an alternative embodiment of the present invention;

FIG. 4 is a flow chart diagram of a method of determining a probability to find a substantially identical copy of a file prior to deleting the file from a file system in accordance with an embodiment of the present invention; and

FIG. 5 is a schematic block diagram of an inbox folder of an exemplary user, to demonstrate an example of an alternative embodiment of the present invention.

### DESCRIPTION OF EMBODIMENTS OF THE PRESENT INVENTION

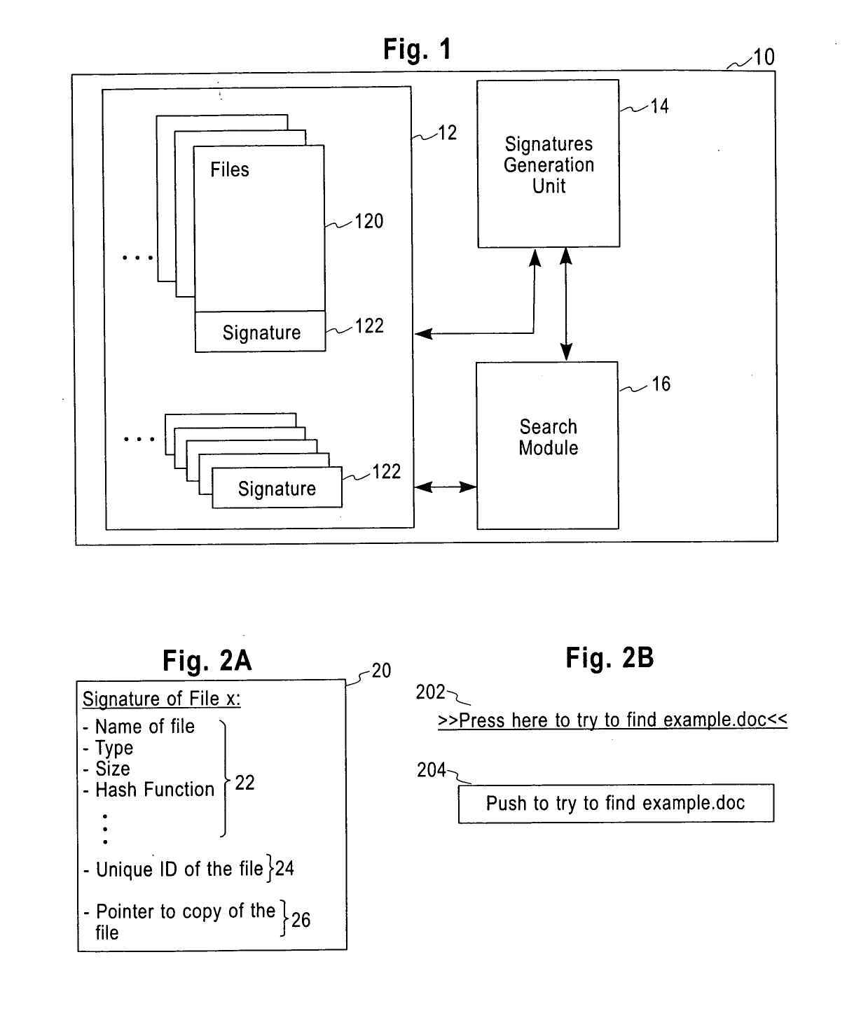

Reference is now made to FIG. 1, which is a simplified block diagram of a system 10 for managing a file system 12 according to an embodiment of the present invention. The term file system is used herein to describe any storage areas in a computer system that provide storage for user programs, data and the programs that control access to this storage, including but not limited to, file systems that are known in the art and e-mail applications.

System 10 may include a file system 12, to store the programs, data, and programs that control access (hereinafter collectively referred to as files 120) or to store signatures 122 of files as will be described in detail below. Files may include, among other items, spreadsheets, email messages, saved web pages, attachments to email messages, etc.

System 10 may further include a signature generation unit 14 to generate signatures of the files that may be stored in or deleted from system 10, as will be described in detail below. System 10 may include a search module 16 to search for files based on the information that is kept in the signature of a deleted file.

Reference is now made to FIG. 2A, which is a simplified block diagram of a signature 20 of a deleted file in accordance with an embodiment of the present invention. Signature 20 is typically a relatively small file in comparison to the file it is related to, and holds information and characteristics of the deleted file that may assist in searching for a copy of the deleted file or for a substantial identical file of the deleted file and in retrieving it. There may be many different types of characteristics stored in signature 20.

A first type of characteristic 22 that may be stored in signature 20 may include information that may assist in identifying the deleted file. Such information may include the name of the deleted file, the type of the deleted file, the size of the deleted file, a hash function of the deleted file, and other information related to the file that may be defined by the user or the administrator of system 10 (shown in FIG. 1). For example, signature 20 may include keywords or other metadata related to the content of the file.

A second type of characteristic 24 that may be stored in signature 20 may include information that may assist in authenticating that a file that is found as a result of a search is identical to the deleted file. For example, signature 20 may include a unique check bit to authenticate the file, or an encrypted ID string of the file. An example of the encrypted ID string may be a hash function of the file needed to verify that it is related to the deleted file. The hash function may be useful in authenticating that a found file is indeed identical to the file that was deleted, as will be described in detail below.

A third type of characteristic 26 that may be stored in signature 20 may include information that may be used to enable efficient retrieval of the deleted file. For example, signature 20 may include a pointer or other reference to a copy of the deleted file.

In accordance with an embodiment of the present invention, the signature or characteristics stored in the signature may be used by search engines as input for a search. For example, a search engine may search for a file based on a specific signature inserted to it as input. In another example, the search engine may receive input such as the specific size of a file, e.g., 1,273,363 bytes, with a specific encrypted ID string, and conduct a search according to these characteristics.

For an efficient search, search engines may index signatures of files in accordance with an embodiment of the present invention to simplify the searches. Accordingly, search queries for signatures or characteristics of signatures, e.g., size, hash function etc., may be performed on the index first, and, if a corresponding file is not found, the search may be performed using non-index-based techniques.

Reference is now made to FIG. 2B, which is a simplified diagram of the way a signature may be displayed to the user in accordance with an embodiment of the present invention. A signature may be displayed to the user to allow an efficient way to search for the file related to the signature. For example, signature 202 may be displayed as a hypertext link, whereas signature 204 may be displayed as a user interface (UI) clickable button. Both examples refer to a signature of a deleted document file, example.doc. Other ways to display signatures to the user may be defined by the user or by the administrator of system 10.

Referring now back to FIG. 1, the signature generation unit 14 may generate a signature of a file before the file is deleted, or, alternatively, it may create a signature of a file upon receipt of the file to system 10. In the first case, the signature may be stored in file system 12, as a future reference in support for attempts to search for copies of the deleted file. In the second case, the signature may be attached to its corresponding file in file system 12 (see the first file 120 in FIG. 1), and it may provide search parameters to search module 16, to provide a rating of the probability of finding other copies of the file. The rating may be attached to the file, or to the signature if the file is deleted afterwards. Examples of the ratings that may be given are popular, if the file was found by the search module 16 with a rate of success greater than a predefined rate of success; limited, if the file was found more than once but less than the rate of success; and unique if the file was not found elsewhere by the search module 16. Other rating schemes may be defined by the user or administrator of system 10. For example, the rating may be defined by percentages showing the probability of finding a substantially identical copy of a file. The percentages may be determined based on factors including, but not limited to, data saved in the file system of files with similar characteristics, the number of files found during the search, etc. In accordance with an embodiment of the present invention, the rating may assist the user in deciding whether or not he is interested in deleting the file.

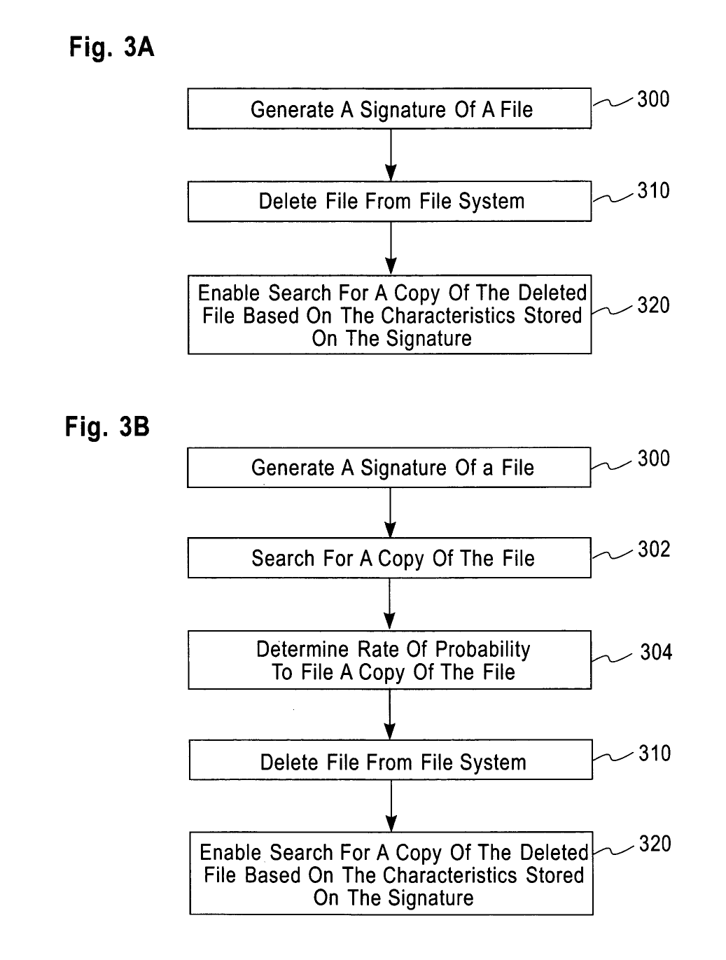

Reference is now made to FIG. 3A, which is a flow chart diagram of a method of managing files in a file system in accordance with an embodiment of the present invention. In the method of FIG. 3A, a signature of a file may be generated (block 300). The signature may store characteristics of the file that may assist in finding the file in the future. These characteristics may be divided into three types as described in detail above. The file for which the signature was generated may then be deleted from the file system (block 310). If, in future reference, the user is interested in finding a copy of the deleted file, a search for a substantially identical copy of the deleted file may be enabled based on the characteristics stored on the signature (block 320).

Reference is now made to FIG. 3B, which is a flow chart diagram of a method of managing files in a file system in accordance with an alternative embodiment of the present invention. The method of FIG. 3B is similar to the method of FIG. 3A with the exception that before deleting the file (block 310), at least one copy of the file may be searched (block 302), and a rating of the probability of finding a substantially identical copy of the file may be determined (block 304). The rating may be calculated based on the results of the search. The search may be performed in the file system to check for duplicates, and/or in additional places as defined or configured by the user or administrator of the system. Such places may be, for example, additional storage databases in the Local Area Network (LAN) of the user, the Wide Area Network (WAN) of the user, the Internet using search engines including, but not limited to, Google, Yahoo, etc., additional databases, mail applications, etc. In addition, the length of the search may also be determined by the user or the administrator. For example, the search may be terminated after finding one copy of the file or after a complete scan of the available resources for the search operation.

The rating of the probability of finding a substantially identical copy of the file may be presented in proximity to the file, e.g., as part of the file properties, or near the name of the file as displayed to the user, etc. Alternatively or additionally, the rating may be presented in proximity to the signature of the file, e.g., as part of the hypertext link that may be presented to the user, etc.

Reference is now made to FIG. 4, which is a flow chart diagram of a method of determining a probability of find a substantially identical copy of a file prior to deleting the file from a file system in accordance with an embodiment of the present invention. At least one copy of a file may be searched (block 400), and the rating of the probability of finding a substantially identical copy of the file may be determined (block 410) based on the results of the search. The rating may be displayed either in proximity to the file or in proximity to the signature of the file (block 420).

As explained above, the search for copies of the file may be performed in the file system to check for duplicates, and/or in additional places as defined or configured by the user or administrator of the system. Furthermore, the length of the search may also be determined by the user or the administrator.

In accordance with an embodiment of the present invention, a policy for managing the file system may be established. The rules of the policy may be based on the probability rating of finding substantially identical copies of deleted files and on additional characteristics related to the file system, e.g., available storage space, users' rights in the file system, security, etc. If the rules are fulfilled by the probability rating and the characteristics related to the file system, the file for which the rules were fulfilled may automatically be deleted from the file system.

For example, a user or an administrator may set a rule in the policy that any file larger than 5 megabytes with a probability of finding of more than 95% may automatically be deleted. In accordance with an additional exemplary rule, files that are larger than 100 kilobytes with a probability of finding of more than 80% may be deleted if the available storage space is below a predefined threshold.

It should be noted that the policy may be dynamically edited by the user or the administrator of the file system.

The example given below shows how a possible embodiment of the present invention may be utilized with a Lotus™ Notes™ (Trademarks of Lotus Corp.) e-mail application. In the example below, the application is defined to provide the rating of the probability of finding a substantially identical copy for each e-mail message, e.g., note, and for each of the attachments of the message, when it is displayed in the user's inbox. The search in this example is defined to be performed on the file system of the user and on the Internet, using Google™ search engine (Trademark of Google Inc.), and it is limited to either finding 7 substantially identical copies of the searched file, or to last 5 seconds. Thereafter, for deleted files or attachments, signatures are generated, enabling a search for a substantially identical copy of the file, such as by searching the file system of the user and the Internet using Google™.

### EXAMPLE

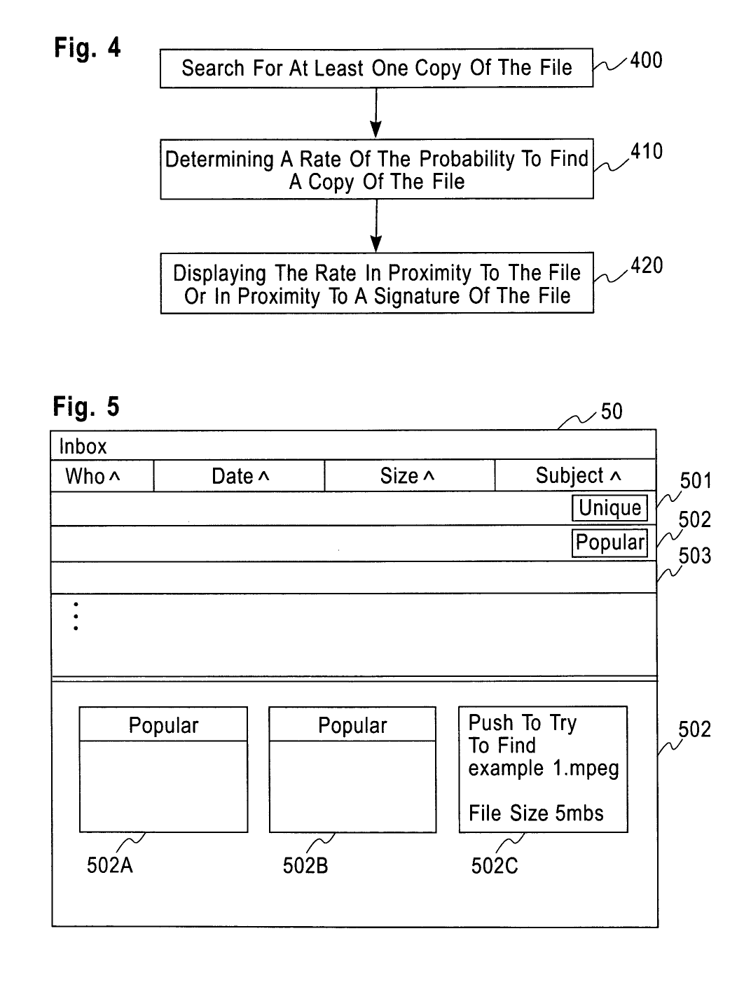

Reference is now made to FIG. 5, which is a schematic block diagram of an inbox folder of an exemplary user, to demonstrate an example of a possible embodiment of the present invention. The e-mail application 50 in the present example is Lotus™ Notes™ (Trademarks of Lotus Corp.), but is should be noted that other e-mail applications may be used. In proximity to each of the displayed messages 501, 502, and 503, ratings are provided to represent the probability of finding a substantially identical copy for each of them. As discussed above, the rating unique related to message 501 indicates that message 501 was not found in the user's file system or in the Internet using Google. The rating popular related to message 502 and to the attachments 502A and 502B (shown in the preview pane in FIG. 5), indicates that these files were found more than 3 times.

Signature 502C′, presented as a UI button, stores the characteristics of deleted attachment 502C. The name of the deleted attachment, example 1, the type of the deleted attachment, MPEG file, and the size of the deleted file, 5 megabytes, are stored on the signature 502C′, as well as a link to a substantially identical copy of the attachment that was previously found when the attachment was deleted. In case the link is no longer valid because the reference was deleted, removed, or is no longer available for the user from another reason, a search for another substantially identical copy of the attachment will be resumed when the user clicks on signature 502C′.

In the description above, numerous specific details were set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code that embodies aspects of the present invention is typically maintained in permanent storage, such as a computer readable medium. In a client-server environment, such software programming code may be stored on a client or server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A method of managing files in a file system, comprising:
generating a signature of a file, said signature storing a plurality of characteristics of said file; and
providing user interface to enable searching for a substantially identical copy of said file based on the characteristics stored on said signature.

2. The method of claim 1, further comprising deleting said file.

3. The method of claim 1, further comprising searching for at least one copy of said file; and
determining a rating of the probability of finding a substantially identical copy of said file based on the results of said searching.

4. The method of claim 3, further comprising deleting said file if said rating is below a given probability threshold.

5. The method of claim 3, further comprising deleting said file.

6. The method of claim 1 wherein said providing user interface comprises presenting a hypertext link to perform a search of said file, said link holding the characteristics of said file.

7. The method of claim 1 wherein said providing user interface comprises presenting a user interface (UI) button, said UI button holding the characteristics of said file.

8. The method of claim 1 wherein said plurality of characteristics includes any one of the following: name of said file, size of said file, type of said file, keywords related to said file, hash function of said file, that allows identifying said file.

9. The method of claim 1 wherein said plurality of characteristics includes a pointer to an identical file that was found.

10. The method of claim 3, further comprising displaying said rating in proximity to said signature.

11. The method of claim 3 wherein said searching is performed in configurable predefined places.

12. The method of claim 3 wherein said searching is performed in any one of the following: a plurality of storage databases in the Local Area Network (LAN), a plurality of storage databases in the Wide Area Network (WAN), the Internet, and in mail applications.

13. The method of claim 3 wherein said searching further comprising sending said signature or a subset of the characteristics of said signature to a search engine for searching said file.

14. A system for managing files in a file system, comprising:
a signature generation module to generate a signature of a file, said signature storing a plurality of characteristics of said file; and
a search module to search for a substantially identical copy of said file based on the characteristics stored on said signature.

15. The system of claim 14 wherein said signature generation module generates a hypertext link to perform a search of said file, said link holds said plurality of characteristics of said file.

16. The system of claim 14 wherein said signature generation module generates a user interface (UI) button, said UI button holds said plurality of characteristics of said file.

17. The system of claim 14 wherein said plurality of characteristics includes any one of the following: name of said file, size of said file, type of said file, keywords related to said file, hash function of said file, that allows identifying said file.

18. The system of claim 14 wherein said plurality of characteristics includes a pointer to an identical file that was found.

19. The system of claim 14 wherein said search module is adapted to search in configurable predefined places.

20. The system of claim 14 wherein said search module is adapted to send said signature or a subset of the characteristics of said signature to a search engine for searching said file.

21. A method of determining a probability of finding a substantial identical copy of a file prior to deleting said file from a file system, comprising:
searching for at least one copy of said file; and
calculating a rating of the probability of finding said substantially identical copy of said file based on the results of said searching.

22. The method of claim 21, further comprising displaying said rating in proximity to said file.

23. The method of claim 21, further comprising displaying said rating in proximity to a signature of said file.

24. The method of claim 21, further comprising:
comparing said rating and a plurality of characteristics related to said file system to at least one rule of a policy for management of said file system; and
if said rule is fulfilled by said rating and said plurality of characteristics related to said file system, automatically deleting said said file from said file system.

25. A computer software product, including a computer-readable medium in which computer program instructions are stored, which instructions, when read by a computer, cause the computer to perform a method of managing files in a file system, comprising:
generating a signature of a file, said signature storing a plurality of characteristics of said file; and
providing user interface to enable searching for a substantially identical copy of said file based on the characteristics stored on said signature.

26. The computer software product of claim 25, further comprising deleting said file.

27. The computer software product of claim 25, further comprising searching for at least one copy of said file; and
determining a rating of the probability of finding a substantially identical copy of said file based on the results of said searching.

28. The computer software product of claim 27, further comprising deleting said file if said rating is below a given probability threshold.

29. The computer software product of claim 27, further comprising deleting said file.

30. A computer software product, including a computer-readable medium in which computer program instructions are stored, which instructions, when read by a computer, cause the computer to perform a method of determining a probability of finding a substantially identical copy of a file prior to deleting said file from a file system, comprising:
searching for at least one copy of said file; and
calculating a rating of the probability of finding said substantially identical copy of said file based on the results of said searching.
